(19) United States
(12) Patent Application Publication
(10) Pub. No.: US 2005/0086456 A1
(43) Pub. Date: Apr. 21, 2005

(54) Addressing scheme to load configuration registers

(76) Inventors: Yaron Elboim, Haifa (IL); Gilad Shmueli, Haifa (IL); Eli Sterin, Moshav-Megadim (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/674,682

(22) Filed: Sep. 29, 2003

(51) Int. Cl. G06F 9/24

(52) U.S. Cl. 713/1

(57) ABSTRACT

Various embodiments in the invention relate to storing information in a memory to load a plurality of configuration registers of an electronic device, where the information includes a plurality of configuration register data and corresponding configuration register address information. Thus, the configuration register data may be loaded to various configuration registers selected according to the configuration register address information. Moreover, during testing it is possible to identify configuration registers which reset to a default data value equal to desired data for achieving a desired device configuration prior to being loaded. Then, the configuration register data and address information for loading those identified registers can be removed from the memory, and the memory size can be reduced by a size necessary to hold the removed configuration register data and address information.

### FIELD

Memory data to load configuration registers.

### BACKGROUND

During initialization and/or use of electronic devices it is often desirable to load configuration registers of the device with data from a memory. For example, during initialization, configuration registers of an Ethernet controller may be loaded with data from a non-volatile memory. The data loaded into the configuration registers may then be used to define communication parameters for communication between the device and another device.

Moreover, during electronic device design it is often desirable to consider which configuration registers may not require loading from a memory for the device to operate properly. Thus, by excluding data in the memory for loading the registers not required it is possible to minimize the expense of the memory necessary to hold the data for loading the configuration registers.

### BRIEF DESCRIPTION OF THE DRAWINGS

Various features, aspects, and advantages will become more thoroughly apparent from the following detailed description, the set of claims, and accompanying drawings in which:

FIG. 1 is a block diagram of a memory for storing data and address information and a device having configuration registers.

FIG. 2 is a flow diagram of a process for loading registers of a device with data from a memory.

FIG. 3 is a flow diagram of a process for loading registers of a device with test data from a memory.

FIG. 4 is a flow diagram of a process for generating desired information in a memory to load registers of a device.

FIG. 5 is a block diagram of a memory designed to have address information and data to load configuration registers that require data and that are not reset with correct default values.

### DETAILED DESCRIPTION

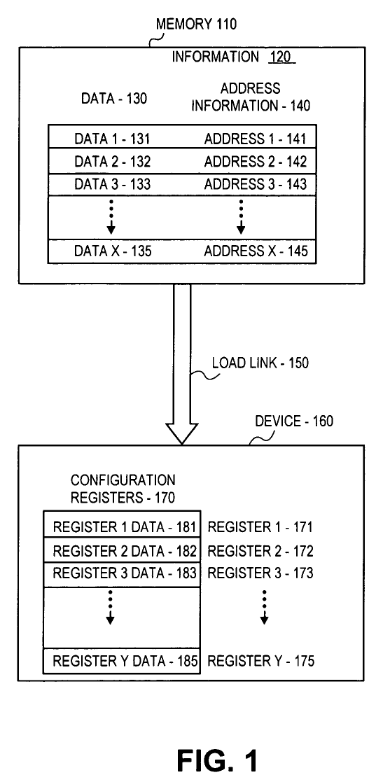

Various embodiments of the invention relate to storing information in a memory to load into a plurality of configuration registers of an electronic device where the information includes a plurality of configuration register address information and a plurality of register data corresponding to the configuration register address information. For example, FIG. 1 is a block diagram of a memory for storing data and address information and a device having configuration registers. As shown in FIG. 1, memory 110 stores information 120 to load configuration registers 170 of device 160. Information 120 includes data 130 having data 1-131, data 2-132, data 3-133, and additional data through data X-135. Information 120 also includes address information 140 having address 1-141, address 2-142, address 3-143, and additional addresses through address X-145. Configuration registers 170 include register 1-171, register 2-172, register 3-173, and additional registers through register Y-175.

Thus, one or more of data 1-131 through data X-135 may correspond with one or more of address 1-141 through address X-145 so that each of address 1-141 through address X-145 identifies at least one of register 1-171 through register Y-175 of configuration registers 170 to which a corresponding data (e.g. one or more of data 1-131 through data X-135) should be written. For example, data 1-131 through data X-135 could correspond to address 1-141 through address X-145 so that memory 110 can include information 120 to load register 1-171 through register Y-175 with register 1 data-181 through register Y data-185 via load link 150. As a result, register 1 data 181 through register Y data-185 would be data 1-131 through data X-135 after loading.

Moreover, in accordance with embodiments, each address, such as address 1-141 corresponds to one data, such as a single address that corresponds to data 1-131. Thus, the memory stores data address pairs where each data is bounded to each address to form an inseparable pair for loading the data to the addressed register. For instance, if there are multiple data for one register address the first data will be written to the register and the second one may also be written to the same register and override the first write.

Furthermore, in accordance with embodiments, data 130 may include less than an amount of data and/or address information 140 may include less than an amount of address information necessary to load each of configuration registers 170. Thus, one or more of register 1-171 through register Y-175 may not contain data from data 130 after loading so that only a portion of configuration registers 170 are loaded with or written with data 130.

In addition, according to embodiments, address information 140 may include address information to load configuration registers 170 in various sequential orders. Thus, address 1-141 may contain the address of a register other than register 1-171 (e.g., such as by address 1-141 being the address of register 3-173). Likewise, address 2-142 may contain the address of register 1-171, address 3-143 may contain the address of register Y-175. Thus, in the example above, address information 140 contains addresses that would not load configuration registers 170 in sequential order and does not contain addresses for each of configuration registers 170 (e.g., in the example above, address information 140 does not include an address for loading register 2-172). Put another way, the memory space that now holds address 1-141 and data 1-131 can hold any other address-data pair, such as for instance by holding the address-data pair for loading register 17 (e.g., which might in other circumstances correspond to address 17 and data 17). Such ordering is available by virtue of having the destination register's address for the data (e.g., the data's addressed register) also stored in memory.

Furthermore, in accordance embodiments, configuration registers 170 may include more or fewer than all of the registers necessary to configure device 160 to a desired configuration. For example, as described further below with respect to block 420, register 1-171 through register Y-175 may not include registers which have a default data value equal to desired data for achieving a desired configuration prior to being loaded (e.g., such as by having data values equal to desired data when reset prior to registers being loaded during an initialization sequence of device 160 or when external settings change for device 160).

According to embodiments, configuration registers are circuits that can hold a value while they are not written with a new value and while there is power in the circuit. For instance, after power is applied to the communication device the value of the registers may not be defined. Then, after power is stable, a global reset signal that is connected to all the registers in the design may change state (0->1 or 1->0) and forces (this forcing is often called “reset”) all the registers into known initial states (usually 0s). For instance, a designer may assign a default value to a register in the design phase and that value will be “inserted” into the register by the reset signal.

More specifically, each configuration register in the design can be reset to its own default value that represents the designer's best estimation of the correct value, and if the designer was correct there is no need to load that register with data from memory (e.g., such as with data from data 130, because that register's default value is a desired data value for that register). Consequently, if there is no need to load the register, there is no need to store a data-address pair corresponding to that register in memory (e.g., for loading that register). Thus, valuable memory space for storing the data-address pair is not needed and can be saved by reducing the size of the memory by the size of the data-address pair. Consequently, a designer can use the reset signal to set any or all of the register into default values during power up or when desired because reset sets a value for each registers during each reset.

Conversely, according to embodiments, configuration registers having critical communication parameters that reset to undesired default values may be loaded from memory by data-address pairs and their default values overridden, such as by a more correct or appropriate values that are discovered after a designer tests the actual device (e.g., such as in a laboratory). Moreover, in a system where the desired values of the configuration registers are risky, novel, or sensitive to variations generated during manufacturing, many of the desired configuration register values will not be known during the design phase. Hence, during design it may be desirable to provide data-address pairs in memory for loading these configuration registers having unknown desired values.

In addition, according to embodiments, if it is known that some registers (like for instance text size in word processing application) are frequently changed by users, it is possible for those registers to be loaded or configured from memory by including space in the memory to store the data-address pair for that register. Thus, it is possible to store data-address pairs in the memory for designs having communication parameters that the desired value is not known for or changes after design. Likewise, according to embodiments, in cases when external settings change the values of configuration registers to undesired communication parameter values, those registers may be loaded from memory according to the data-address pairs described herein. More particularly, in accordance with some embodiments, the usual set of communication parameters that change from system to system may be loaded in an “auto-read” mode, while the large number of analog parameters are loaded according to the data-address pairs in memory described herein.

For example, during design, two conflicting constraints often considered are: (1) reducing the number of configurable registers loaded from memory in the design to reduce memory size; and (2) enlarging the number of configurable registers in the design so that (a) design time can be reduced because extra configurable registers allow the design to be completed even when all the communication parameters are not exactly known, and (b) flexibility to load configurable registers with different data can be preserved to update register desired data inconsistencies resulting from variations between the device design and the devices produced (for instance, in some cases, electrical parameters in the actual silicon device are very different from the estimations used for simulations).

Thus, in some embodiments, data 130 may include data (1) defining analog communication parameters having a desired values that are better left undefined during the design phase for the device (e.g., such as, so that changes to the communication parameters values be made later, after manufacturing), (2) defining analog communication parameters having desired values, but (3) excluding analog communication parameters for configuration registers having default values equal to desired values (e.g., such as reset values for the registers). Moreover, in some instances, most of the configuration registers will have default values that are desired values, so that it is not necessary to load more than half of all the registers from memory.

According to embodiments memory 110 may be various types of appropriate memory for storing information to load registers, such as non-volatile memory, Electrically Eraseable Programmable Read-Only Memory (EEPROM), and Flash Memory. Also, according to embodiments, each of data 1-131 through data X-135 may be a data word of register data and each of address 1-141 through address X-145 may be a data word of register address information corresponding to one of the data words of register data. Thus, for example, data 1-131 may be an 8-bit data word of register data corresponding to address 1-141 which is an 8-bit register address, and the structure of memory 110 may be organized so that data 1-131 and address 1-141 combine to form a 16-bit EEPROM word including register data bits 7:0 and register address bits 15:8. As a result, for each 16-bit word including register data and register address, the 8-bit data word of register data (e.g., such as data 2-132) can be loaded or written to a configuration register in accordance with the 8-bit register address of that 16-bit word, so that the register data of that configuration register is overwritten with or becomes the 8-bit data word of register data of the 16-bit word. For instance, 8-bit address 2-142 identifies register 3-173 as the register that 8-bit data 2-132 is to be written to, so that when information 120 is loaded to device 160, register 3 data 183 is written to with and becomes 8-bit data 2-132.

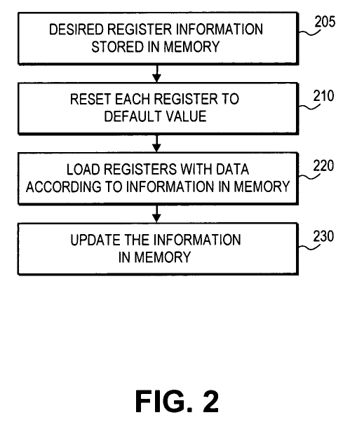

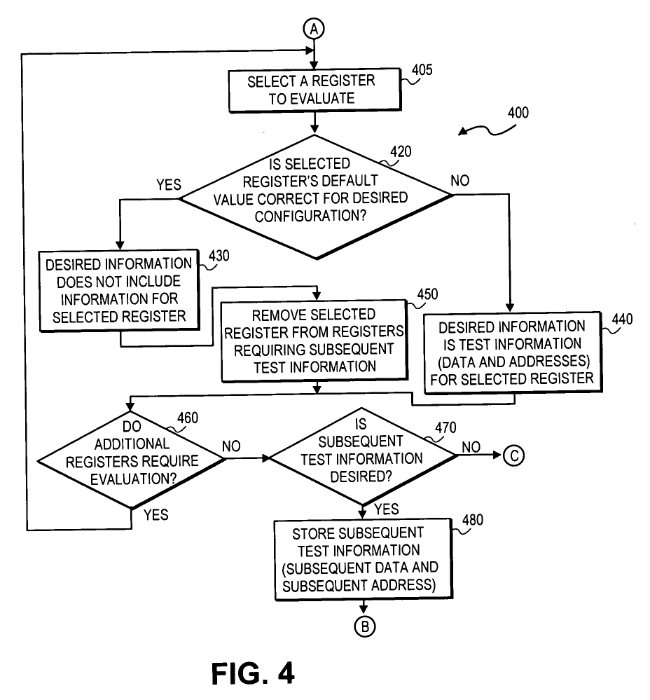

FIG. 2 is a flow diagram of a process for loading registers of a device with data from a memory. As shown in FIG. 2, at block 205 desired register information may be stored or may have previously been stored or burned in a memory. For example, desired registration information stored in memory at block 205 may be equal to, and/or include desired information generated at block 370 as described below and/or in accordance with the process described below with respect to FIG. 4. Subsequently, at block 210 each of a plurality of registers (e.g., such as configuration register 170) of a device (e.g., such as device 160) is reset to a register default data value (e.g., such as a default reset data value for register 1 data 181 through register Y data 185). Then, at block 220 the configuration registers are loaded with data according to information (e.g., such as information 120) stored in a non-volatile memory (e.g., such as memory 110). Furthermore, to assign specific data to specific registers, the information in memory includes a plurality of address information (e.g., such as address information 140) and a plurality of corresponding data (e.g., such as data 130). Hence, as described above for FIG. 1, each of the plurality of address information (e.g., such as each of address 1-141 through address X-145) identifies at least one of the plurality of registers (e.g., such as register 1-171 through register Y-175) to which a corresponding data (e.g., such as data 1-131 through data X-135) should be written (e.g., such as by writing over register 1 data 181 through register Y data 185).

Consequently, according to embodiments, loading, such as described above with respect to block 220, may occur during initialization of a communication controller device, such as during communication register initialization data loading of internal configuration registers of an analog communication device. Moreover, block 220 may also occur during or as a result of a change in communication device external settings.

After block 220, at block 230, information stored in the memory (e.g., such as information 120 stored in memory 110) may be updated with a second plurality of address information (e.g., such as a second set of address information 140) and/or a second plurality of data (e.g., such as second plurality of data 130) corresponding to the first or second plurality of address information. For example, it may be necessary for block 230 to subsequently update information 120 to (1) fix “bugs”, (2) increase configuration capability for device 160, (3) update configuration register values during design and/or testing, (4) update configuration register values during or as a result of a change in communication device external settings, and/or (5) for various other appropriate reasons. Therefore, by updating the address information and/or data stored in the memory, a new set of address information identifying one or more of the configuration registers, and/or a new set of data to load or to be written to the configuration registers may replace the prior information in information 120.

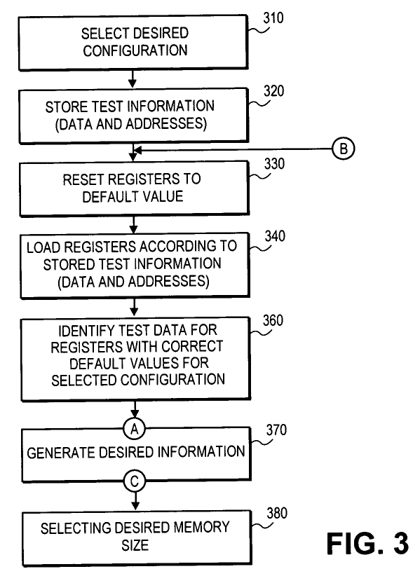

For example, information stored in memory can be subsequently updated, such as during a memory and/or device design stage, or to correct a configuration of a device produced by loading configuration registers as described above with respect to block 220. Specifically, for instance, FIG. 3 is a flow diagram of a process for loading registers of a device with test data from a memory. At block 310 a desired configuration of a device (e.g., such as device 160) is selected where the desired configuration is associated with desired data to be stored in a plurality of registers of a device (e.g., such as data to be stored in configuration registers 170 of device 160). At block 320, test information associated with the desired configuration (e.g., such as information 120) is stored in a memory (e.g., such as memory 110). Specifically, according to embodiments, the test information may include a register address and corresponding register data for each one of the plurality of registers. Thus, as shown in FIG. 1, the test information may include a register address, such as address 1-141, and corresponding register data, such as data 1-131, for each one of register 1-171 through register Y-175.

Next, at block 330, each of the plurality of register (e.g., such as register 1-171 through register Y-175) is reset to a register default data value (e.g., such as a default reset data value for one or more of register 1 data 181 through register Y data 185). Note that according to embodiments, it is possible to begin the process shown in FIG. 3 at block 330 and to perform that process without blocks 320 and 340, such as to run a test on a chip in a laboratory, to measure communication accuracy and performance of the communication device with the configuration registers loaded only with default values. Then, if performance, accuracy, and/or other factors indicate that the default values do not provide a desired configuration, the process shown in FIG. 3 can be run beginning at block 320.

Subsequently, at block 340 any number of the plurality of registers (e.g., such as 1, 2, any number of the plurality, or all of register 1-171 through register Y-175) is loaded according to the test information (e.g., such as information 120), such as is described above with respect to block 220.

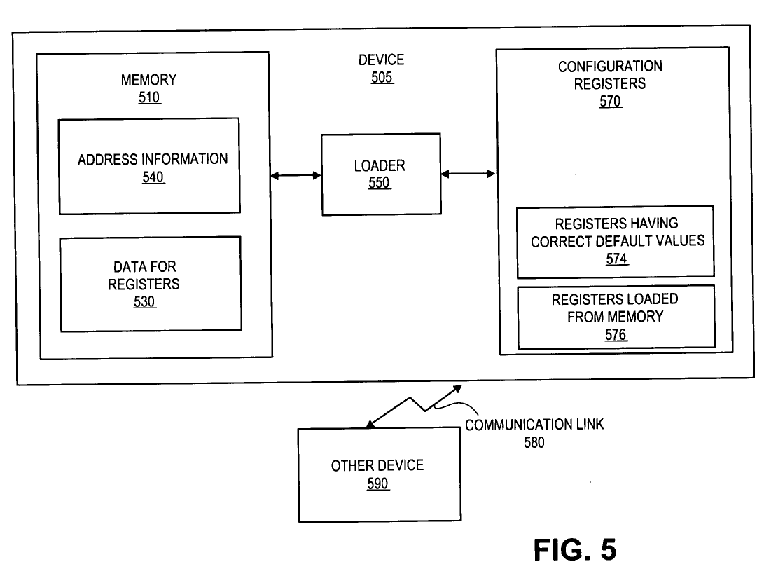

After block 340, at block 360, a subset of the plurality of test data (e.g., such as a subset of data 1-131 through data X-135) may be identified that corresponds to a subset of the plurality of registers having default data values equal to desired data for achieving the desired configuration prior to loading the registers (e.g., such as corresponding to a subset of register 1-171 through register Y-175 having default data values equal to desired data as will be described further below with respect to block 420 of FIG. 4 and registers 574 of FIG. 5).

Moreover, any or all of blocks 310, 320, 330, 340, and/or 360 may occur during a memory design validation stage, such as a validation stage for memory 110 as described above. Also, in embodiment, block 360 may occur before or after block 330. Moreover, in embodiments block 330 may correspond with block 210 and/or block 340 may correspond with block 220 as described above, such as if blocks 330 and 340 occur during initialization of a communication controller device, or other device, such as a device described above with respect to device 160. Furthermore, block 330 may occur before block 310 and/or before block 320.

At block 370, desired information is generated, such as information 120 associated with a desired configuration as described above with respect to block 310. Moreover, in embodiments, desired information may be the same information as desired register information as described above with respect to block 205. At block 380 a desired memory size is selected as will be explained further after the description of FIG. 4 below.

FIG. 4 shows process 400, which may or may not represent block 370 in embodiments, to generate desired information. Thus, FIG. 4 is a flow diagram of a process for generating desired information in a memory to load registers of a device. For example, the process may begin at “A” as shown in block diagrams of FIGS. 3 and 4. Referring now to FIG. 4, at block 405, a register is selected for evaluation (e.g., such as register 1-171). Also note that, according to embodiments, selection of a register to evaluate at block 405 may be performed, such as by selecting a sequence of all or less than all of the configuration registers (e.g., all or less than all of configuration registers 170), such as by a computer, piece of test equipment, and/or person using or not using software and in accordance with appropriate criteria such as criteria related to the design of a memory, such as memory 110 and/or design of a device such as device 160 as explained above.

At decision block 420 it is determined whether the selected register's default value is equal to desired data for achieving the desired configuration prior to loading the selected register, such as from a memory. Hence, for selected register 1-171 it would be determined whether register 1-171 includes register 1 data 181 equal to a value of desired data (e.g., such as if register 1 data 181 is already equal to desired data, such as data 1-131 prior to loading register 1-171 with data 1-131). Specifically, desired data for register 1-171, such as data 1-131, may not be required, such as if register 1 data 181 is identified at block 360 as having been already equal to desired data upon being reset as described above with respect to block 330, and prior to being loaded as described above with respect to block 340. For instance, register 1 data 181 may be identified as being reset to desired data when reset to a data valued at block 330 that is a valued used in a prior test resulting in superior communication performance, accuracy, and/or other factors for the device as compared to the results after the register is loaded from memory in the current instance. In other words, register 1-171 may be reset at block 330 to a first data value that was loaded from memory into register 1-171 during a previous test or simulation, and that provided a more desirable configuration as shown by the prior test results, as compared to the test results when register 1 data 181 is loaded with data 1-131 at block 340 for the current test. Thus, the register data value used during the prior communication test and used as the reset valued for the register during the current test is identified as a correct default valued for that register for the desired configuration. Note that in embodiments, the process of block 420 may be performed, such as by evaluating data resulting from the process of block 360.

If at block 420 the selected register's default value is not identified as correct for the desired configuration then the process continues to block 440. At block 440 the desired information is the test information for the selected register. For instance, for selected register 1-171, if that register's default value is not identified as correct for the desired configuration (e.g., such as by comparing communication test results for the default value and for the loaded valued), then the test data loaded to register 1-171, such as data 1-131 is or becomes the desired data and the corresponding address is or becomes the desired address information for register 1-171. Furthermore, in accordance with embodiments, although the selected register's default value is not correct for the desired configuration, test data loaded to the selected register and address information may not be or become the desired information for that register. For example, the data loaded to the selected register may fail to achieve a desired configuration (e.g., such as if test results for the loaded data do not have sufficient communication performance, accuracy, and/or other factors for the device as compared to what is desired or test results with other data in the register).

Similarly, according to embodiments, address-data pairs identified as desired information (e.g., such as address information identifying the selected register and corresponding data to load to the selected register identified at block 440) may be stored at various positions within information 120. For instance, address-data pairs identified as desired information may be stored at various positions for subsequent test or configuration of memory 110 according to selection criteria determined by a computer, piece of test equipment, or person as described above with respect to block 405. After block 440, the process proceeds to decision block 460 where it is determined whether additional registers require evaluation.

If at decision block 420 it is determined that the selected register's default value is correct for the desired configuration, then the process also proceeds to block 430. At block 430 the desired information does not include information required for the selected register. After block 430, the process continues to block 450. At block 450 the selected register is removed from registers requiring subsequent test information. After block 450 the process continues to decision block 460 where it is determined whether additional registers require evaluation.

If at decision block 460 additional registers do require evaluation then the process returns to block 405. However, if at decision block 460 it is determined that additional registers do not require evaluation, then the process continues to decision block 470. At decision block 470 it is determined whether subsequent test information is desired. If subsequent test information is desired then the process may proceed to block 480 where subsequent test information may be stored such as in a memory, such as described above with respect to memory 110. More particularly, in the case of a non-volatile EPPROM memory, the current information in the memory may be erased such as by exposing or radiating the memory with ultraviolet light, and then the subsequent test information may be stored, such as by “burning” it into the EPPROM memory. After block 480, the process may continue to “B” as identified in FIGS. 3 and 4. In accordance with embodiments subsequent test information may include some or all of the same address information and/or same data information as provided in the original test information. For instance, test information and/or subsequent test information may contain data values for pairs of data 130 and corresponding address information 140 for testing various configurations of communication device in order to determine optimal communication, such as described above with respect to block 420, and below with respect to blocks 370 and 380.

On the other hand, if at decision block 470 subsequent test information is not desired, the process may continue to “C” as shown in FIGS. 3 and 4. Moreover, in accordance with embodiments, the decision as to whether additional registers require evaluation at decision block 460, the decision as to whether subsequent test information is desired at decision block 470, and the selection of subsequent test information to be stored, such as at block 480, may also be determined by a computer, piece of test equipment, and/or person as described above with respect to block 405.

Furthermore, in accordance with embodiments, block 370 (e.g., such as the process described and shown with respect to FIG. 4) may be performed at various appropriate times during design and/or test of a device such as device 160 as described above with respect to block 230 and/or FIG. 3 (e.g., such as using a memory, such as memory 110). Thus, tests may be performed by testing analog circuits multiple times with slightly different communication parameters loaded into configuration registers from memory (e.g., via data-address pairs) to conclude which configuration yields the best performance, accuracy, and/or other desired results. For example, block 370 (e.g., such as the process of FIG. 4) may be performed at any time after block 330 of FIG. 3, such as by performing the process of block 360 (e.g., and such as by performing blocks 405 through block 480 as necessary of FIG. 4) prior to performing the process of block 340 of FIG. 3.

Consequently, in accordance with embodiments, the determination as to whether subsequent test information is desired at decision block 470 may rely upon the quantity and type of registers that require subsequent test information (e.g., such as registers not removed, at block 450 and/or registers not containing desired information at block 440) as well as consideration as to whether the “desired information” at block 440 is proper information for a desired configuration (e.g., such as by a determination whether information loaded at block 340 is proper for achieving a desired configuration, wherein such a determination may be made by a computer, a piece of test equipment, and/or person as described above with respect to block 405).

In an embodiment where FIG. 4 represents block 370, at “C” the process of FIG. 4 may return to FIG. 3 at block 380 where a desired memory size is selected. For example, according to embodiments, a desired memory size may be a memory having: (1) a memory size less than or equal to a memory size sufficient to store desired information (e.g., such as information identified as desired information in accordance with block 370 and the process described with respect to FIG. 4); (2) a memory size less than or equal to a memory size sufficient to fill all the registers (e.g., a memory size less than or equal to a memory size sufficient to fill all of configuration registers 170); (3) a memory size arrived at by reducing a size of the current memory used to store the test information (e.g., such as memory 110 as described above) by a memory size sufficient to store a subset of the plurality of test data and the corresponding test address information (e.g., such as described above with respect to block 360, block 420, and/or as described below with respect to registers 574); and/or (4) a memory size sufficient to store data-address pairs as described above for FIG. 1, with respect to data 130 and corresponding address information 140.

As a result, in accordance with embodiments, it is possible to configure different registers by test loading those registers with different values, such as during the validation stage of device 160, so as to identify registers during testing that are reset with correct default values, for a desired configuration of device 160. Specifically, for instance, address information 140 may be used to write or load various data in data 130 to different ones of configuration registers 170 during a number of reset and loading tests of configuration registers 170 until only the desired registers of configuration registers 170 that do not reset to desired values are loaded with data from data 130. Then, the data from data 130 that is not necessary to load those desired registers, and any corresponding address information in address information 140, can be moved from information 120. Hence, the size of memory 110 can be reduced by a size necessary to contain the data and corresponding addresses not necessary to load the desired registers.

For example, according to embodiments, the determination of which registers are desired to be loaded can be evaluated by a computer, piece of test equipment, and/or person as described above with respect to block 405. Moreover, according to embodiment, the determination may be made by weighing the number of registers desired against the size of memory 110 required to store data 130 and address information 140 to load the data into those registers. For instance, the determination may consider the risk and costs related to the potential future need to change or update data and/or addresses in information 120, and/or increase the size of memory 110 (e.g., such as to store additional information in information 120); as well as a cost analysis based on designing memory 110 to have a memory size required to store desired information. For example, after configuration, testing, and manufacture of products including device 160 and memory 110, it may be necessary to subsequently update information 120 and/or the size of memory 110 to fix “bugs” and/or increase configuration capability for device 160 (e.g. also see as described above with respect to block 230). Specifically, subsequent update may be desired prior to distribution of manufactured products including device 160 and memory 110; during a subsequent design of device 160 and/or memory 110; and/or after distribution of products including device 160 and memory 110.

For instance, FIG. 5 is a block diagram of a memory designed to have address information and data to load configuration registers that require data and that are not reset with correct default values. As shown in FIG. 5, device 505 includes memory 510, loader 550, and configuration registers 570. In accordance with embodiments, device 505 may be a device as described above with respect to device 160 and/or memory 510 may be a memory such as described above with respect to memory 110. Memory 510 includes address information 540 and data for registers 530. Furthermore, configuration registers 570 may be registers for loading as described above with respect to block 220. Also, for instance, configuration registers 570 may be used to define parameters for communication between device 505 and at least one other device, such as other device 590 via one or more communication links, such as communication link 580. Specifically, in accordance with embodiments, device 505 may be a processor (e.g., such as computer processor, communication processor, or other appropriate electronic processor), a memory controller (e.g., such as for controlling a memory such as described above with respect to memory 110), and an Ethernet controller (e.g., such as a Giga bit controller, or other appropriate Ethernet controllers implementing non-volatile memory to load configuration registers), and/or an analog communication device.

Furthermore, configuration registers 570 include registers having correct default values 574, and registers loaded from memory 576. For example, registers having correct default values 574 may be registers associated with the process described above with respect to block 360 and/or block 420. Similarly, registers loaded from memory 576 may include registers associated with the process described above with respect to block 220 and/or block 340. Therefore, in accordance with embodiments, the memory size of memory 510 may be a memory size less than or equal to a memory size sufficient to fill all of configuration registers 570, a memory size sufficient to store address information 540 and corresponding data for registers 530 sufficient to load registers loaded from memory 576, and/or a size as described above with respect to selecting a desired memory size at block 380.

Also, in accordance with embodiments, loader 550 coupled to memory 510 and configuration registers 570, may include one or more of a block of control logic, loading logic, logic gates, multiplexers, switches, a processor, firmware, a controller and/or other appropriate circuitry for routing or directing data for registers 530 to be written to configuration registers 570 according to address information 540. Specifically, for instance, loader 550 may be a small block of control logic to write or load a plurality of data stored at data for registers 530 to registers loaded from memory 576, in accordance with a plurality of address information stored at address information 540. Additionally, configuration registers 570 (e.g., such as registers loaded from memory 576) may be loaded during an initialization of device 505, and/or loaded as described above with respect to block 220 and/or block 340.

Finally, in accordance with embodiments, memory 510, loader 550, and/or configuration registers 570 may be contained in one or more common or separate devices, chips, printed circuit boards, software modules, computers, and/or various other appropriate hardware or software entities. Thus, for example, memory 510 may be a non-volatile memory chip (e.g., such as an EEPROM) storing information for loading configuration registers of an Ethernet communication controller (such as a controller including one or more chips) on a printed circuit board.

In the foregoing specification, the invention has been described with reference to specific embodiments thereof. However, it will be evident that various modifications and changes may be made thereto without departing from the broader spirit and scope of the invention as set forth in the claims. The specification and drawings are, accordingly, to be regarded in an illustrative rather than a restrictive sense.

1. A device comprising:
a non-volatile memory storing information to load a plurality of configuration registers of a device, wherein the information includes a plurality of address information and a plurality of data corresponding to the plurality of address information, each of the plurality of address information identifying at least one of the plurality of configuration registers to which a corresponding data should be written.

2. The device of claim 1, wherein the non-volatile memory is an Electrically Erasable Programmable Read-Only Memory (EEPROM) and the configuration registers are used to define parameters for communication between the device and at least one other device.

3. The device of claim 1, wherein the plurality of configuration registers include internal configuration registers of an analog communication device.

4. The device of claim 1, wherein the device is one of a processor, a memory controller, and an Ethernet controller.

5. The device of claim 1, wherein the non-volatile memory has a memory size less than or equal to a memory size sufficient to fill all the configuration registers.

6. The device of claim 1, further comprising a block of control logic coupled to the memory, the block of control logic to write the plurality of data to the plurality of configuration registers according to the plurality of addresses information.

7. The device of claim 1, wherein the plurality of configuration registers are to be loaded during an initialization of the device.

8. A method comprising:
resetting each of a plurality of configuration registers of a device to a register default data value; then loading the plurality of configuration registers according to information stored in a non-volatile memory, wherein the information in a memory includes a plurality of address information and a plurality of data corresponding to the plurality of address information, each of the plurality of address information identifying at least one of the plurality of to which a corresponding data should be written.

9. The method of claim 8, wherein loading occurs during initialization of a communication controller device.

10. The method of claim 8, further comprising:
updating the information stored in the non-volatile memory with a second plurality of address information and second a plurality of data corresponding to the second plurality of address information, each of the second plurality of address information identifying at least one of the plurality of to which a corresponding one of the second plurality of data should be written.

11. A method comprising:
a) selecting a desired configuration of a device, the desired configuration associated with desired data to be stored in a plurality of registers of the device;
b) storing test information associated with the desired configuration in a memory;
c) resetting each of the plurality of registers to a register default data value;
d) loading at least two of the plurality of registers according to the test information, wherein the test information includes a plurality of test address information and a plurality of test data corresponding to the plurality of test address information, each of the plurality of test address information identifying at least one of the plurality of registers to which a corresponding test data should be written;
e) identifying a subset of the plurality of test data that correspond to a subset of the plurality of registers having default data values equal to desired data for achieving the desired configuration prior to loading.

12. The method of claim 11, wherein the test information includes a register address and corresponding register data for each one of the plurality of registers.

13. The method of claim 11, wherein each of the plurality of test data is a data word of register data, and each of the plurality of test address information is a data word of register test address information corresponding one of the data words of register data.

14. The method of claim 11, wherein loading occurs during a memory design validation stage.

15. The method of claim 11, wherein identifying occurs after loading.

16. The method of claim 11, wherein resetting and loading occur during initialization of a communication controller device.

17. The method of claim 11, further comprising generating a desired information associated with the desired configuration, wherein generating comprises:
if there exists at least one of the plurality of test data corresponding to one of the plurality of registers having default data values equal to desired data for achieving the desired configuration prior to loading, then storing subsequent test information and repeating c), d), and e) using the subsequent test information;
else identifying the desired information to be the test information.

18. The method of claim 17, further comprising selecting a desired memory that is less than or equal to a memory size sufficient store the desired information.

19. The method of claim 18, wherein selecting a desired memory includes reducing a size of the memory by a memory size sufficient to store the subset of the plurality of test data and the corresponding test address information.

20. A system comprising:
a plurality of configuration registers of an Ethernet controller device;
a non-volatile memory configured to store information to load at least two of the plurality of configuration registers, wherein the information in the non-volatile memory comprises a plurality of address information and a plurality of data corresponding to the plurality of address information, each of the plurality of address information identifying at least one of the plurality of configuration registers to which a corresponding data should be written; and
a block of control logic coupled to the non-volatile memory, the block of control logic adapted to write the plurality of data to the plurality of configuration registers according to the plurality of address information.

21. The system of claim 20, wherein the memory is an Electrically Erasable Programmable Read-Only Memory (EEPROM).

22. The system of claim 20, wherein the non-volatile memory has a memory size less than or equal to a memory size sufficient to fill all the configuration registers.
